(19) United States
(12) Patent Application Publication
(10) Pub. No.: US 2026/0253075 A1
(43) Pub. Date: Aug. 27, 2026

(54) SYSTEM AND METHOD FOR MONETARY TRANSACTION

(71) Applicants: Rajendra Kumar Mohan RANEY, Mumbai (IN); Ravindrakumar YADAV, Panvel (IN); Abhijeet DAIGAVANE, Nagpur (IN)

(72) Inventors: Abhijeet DAIGAVANE, Nagpur (IN); Vasu Dheeraj BAVISETTI, New Delhi (IN)

(21) Appl. No.: 19/144,208

(22) PCT Filed: Apr. 5, 2023
(86) PCT No.: PCT/IB2023/053453

§ 371 Date: Jun. 27, 2025

(30) Foreign Application Priority Data
Apr. 5, 2022 (IN) 202221020555

(51) Int. Cl. G06Q 20/40

(52) U.S. Cl. CPC G06Q 20/401

(57) ABSTRACT

System (100) and method (200) for monetary transaction. The system (100) includes at least two chip (102) incorporated into a monetary transaction means (104). The at least two chip (102) is configured to initiate the monetary transaction. The system (100) also includes a processor (106). The system (100) also includes a memory (108) comprising a set of instructions which when executed by the processor (106) cause the processor (106) to transfer a pre-defined amount of money to a pooled account (110) via a network (112); convert the pre-defined amount of money into equivalent virtual money; perform the monetary transaction via the monetary transaction means (104) in a closed loop manner at a transaction end; and receive the pre-defined amount of money transacted via the monetary transaction means (104) at a receiving end (116).

### FIELD OF DISCLOSURE

The present disclosure relates to monetary transaction. More particularly, the present disclosure relates to a system and method for monetary transaction in an offline mode.

### BACKGROUND OF THE DISCLOSURE

The background description includes information that may be useful in understanding the present invention. It is not an admission that any of the information provided herein is prior art or relevant to the presently claimed invention, or that any publication specifically or implicitly referenced is prior art.

A monetary transaction is one in which one institutional unit makes a payment or incurs a liability stated in units of currency. Monetary transactions are conventionally performed via physical cash which isprinted and is maintained by an authorised entity. However, in such conventional approach, a user needs to carry physical cash all the time. In addition, such physical case is prone to theft. With a growth in technology, and from the invent of digital currency, a newer approach can be seen where the monetary transactions are performed viacards, whose transaction reflects with the connectivity of internet. However, in such newer approach, the transaction fails when the internet connectivity fails. Such limitations make the newer approach less reliable and less efficient.

Therefore, there is a need in the art to provide an improved system and method for monetary transaction which overcomes above-mentioned and other limitations of existing approaches.

### OBJECTS OF THE INVENTION

Some of the objects of the present disclosure, which at least one embodiment herein satisfies, are as listed herein below.

It is an object of the present disclosure to provide system and method tofor monetary transaction.

It is another object of the present disclosure to provide a system and method to for offline monetary transaction.

It is yet another object of the present disclosure to provide a more reliable and more efficient system and method for offline monetary transaction.

It is yet another object of the present disclosure to provide a system and method of dual wallet on single or dual chip cards.

It is yet another object of the present disclosure to provide a system and method to work under Closed loop wallet which is capable to work in parallel with existing traditional online/offline wallet.

### SUMMARY

This summary is provided to introduce simplified concepts of a system and method for dynamic evasive trajectory planning of a host vehicle on a road, which are further described below in the Detailed Description. This summary is not intended to identify key or essential features of the claimed subject matter, nor is it intended for use in determining/limiting the scope of the claimed subject matter.

The present disclosure relates to monetary transaction. More particularly, the present disclosure relates to a system and method for monetary transaction in an offline mode.

An aspect of the present disclosure relates to a system for monetary transaction. The system includes at least two chips incorporated into a monetary transaction means. The at least two chips is configured to initiate the monetary transaction. The system also includes a processor. The system also includes a memory comprising a set of instructions which when executed by the processor cause the processor to transfer a pre-defined amount of money to a pooled account via a network; convert the pre-defined amount of money into equivalent virtual money; perform the monetary transaction via the monetary transaction means in a closed loop manner at a transaction end; and receive the pre-defined amount of money transacted via the monetary transaction means at a receiving end.

Another aspect of the present disclosure relates to a method for monetary transaction. The method includes incorporating at least two chips into a monetary transaction means for initiating the monetary transaction. The method also includes transferring a pre-defined amount of money to a pooled account via a network. The method also includes converting the pre-defined amount of money into equivalent virtual money. The method also includes performing the monetary transaction via the monetary transaction means in a closed loop manner at a transaction end. The method further includes receiving the pre-defined amount of money transacted via the monetary transaction means at a receiving end.

Various objects, features, aspects and advantages of the present disclosure will become more apparent from the following detailed description of preferred embodiments, along with the accompanying drawing figures in which like numerals represent like features.

Within the scope of this application it is expressly envisaged that the various aspects, embodiments, examples and alternatives set out in the preceding paragraphs, in the claims and/or in the following description and drawings, and in particular the individual features thereof, may be taken independently or in any combination. Features described in connection with one embodiment are applicable to all embodiments, unless such features are incompatible.

### BRIEF DESCRIPTION OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure. The diagrams are for illustration only, which thus is not a limitation of the present disclosure, and wherein:

FIG. 1 illustrates an exemplary block diagram of a system for monetary transaction in accordance with an aspect of the present invention.

FIG. 2 illustrates an exemplary representation of a flow chart representing steps involved in a method for monetary transaction in accordance with an aspect of the present invention.

FIG. 3 refers to the exemplary computer system in which or with which embodiments of the present invention can be utilized, in accordance with embodiments of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the scope of the present disclosure as defined by the appended claims.

In the following description, numerous specific details are set forth in order to provide a thorough understanding of embodiments of the present invention. It will be apparent to one skilled in the art that embodiments of the present invention may be practiced without some of these specific details.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Embodiments of the present invention may be provided as a computer program product, which may include a machine-readable storage medium tangibly embodying thereon instructions, which may be used to program a computer (or other electronic devices) to perform a process. The term “machine-readable storage medium” or “computer-readable storage medium” includes, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware). A machine-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-program product may include code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Various terms as used herein are shown below. To the extent a term used in a claim is not defined below, it should be given the broadest definition persons in the pertinent art have given that term as reflected in printed publications and issued patents at the time of filing.

The present disclosure relates to monetary transaction. More particularly, the present disclosure relates to a system and method for monetary transaction in an offline mode.

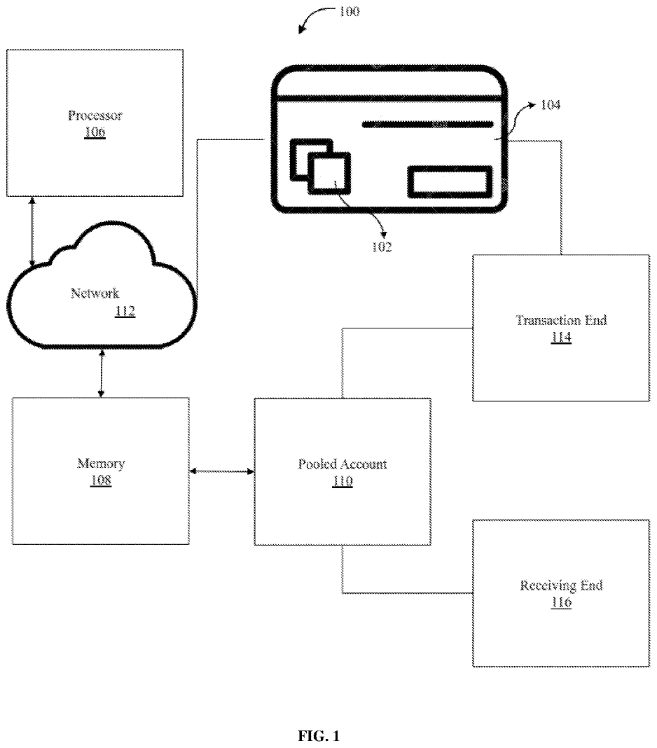

FIG. 1 illustrates an exemplary block diagram of a system for monetary transaction in accordance with an aspect of the present invention. The system 100 includes at least two chips 102 incorporated into a monetary transaction means 104. The at least two chip 102 is configured to initiate the monetary transaction.

The system 100 also includes a processor 106 operatively coupled to the corresponding at least two chip 102. The system 100 further includes a memory 108 operatively coupled to the processor 106; the memory 108 includes a set of instructions. The system 100 includes a server, a monetary transaction means and a device at a receiving end, which are communicatively coupled to each other via he processor 106 and the memory 108 through a network 112.

The memory 108 when executed by the processor cause the processor to transfer a pre-defined amount of money to a pooled account 110 via the network 112. In one exemplary embodiment, the pre-defined amount of money may be in the form of digital currency which may be directly transferred to the pooled account 110.

The processor 106, in one embodiment, may beconfigured to convert the pre-defined amount of money into equivalent virtual money. In one embodiment, the process 106 may covert the pre-defined amount of money into the virtual money using a pre-defined set of instructions. In one specific embodiment, the pre-defined amount of transferred money may be converted into virtual money of any currency of interest of a user.

The processor 106 is configured to sync the monetary transaction means and the receiving end prior to initiating the monetary transaction. In one embodiment, a communication may be created between the monetary transaction means and a device at the receiving end. In one embodiment, the monetary transaction means 104 may include at least one of a debit card, a credit card or a prepaid card. In such embodiment, at least one of the debit card and the credit card may be one of a dual chip single interface card or a single chip dual interface card. In one specific embodiment, the at least one chip may correspond to a contactless chip.

Furthermore, the processor 106 is configured to sync the monetary transaction means and the receiving end 116 prior to initiating the monetary transaction. In one embodiment, the syncing of the monetary transaction means and the receiving end 116 may include sharing and storing the data associated with the monetary transaction means on a device at the receiving end 116. In one exemplary embodiment, the receiving end 116 may be at least one of a POS, a mobile embedded application, a kiosk, or the like.

The processor 106 is also configured to receive a communication signal at the receiving end 116 by the monetary transaction means when the user initiates the transaction. More specifically, the user upon loading the money into the pooled account, gets the monetary transaction means near the device at the receiving end 116. The receiving end 116 with the help of the server keeps the track of the pooled account and the monetary transaction means. Upon identifying the card, the communication signal gets generated between the monetary transaction meansand the receiving end 116. This makes the monetary transaction means ready to be used in a closed loop offline environment.

Furthermore, the processor 106 is configured to receive a security code entered by the user on an interface of the receiving end upon initiating the monetary transaction. In operation, when the user is a place or a situation where the internet connectivity of not available, the user initiates the monetary transaction by either swiping or tapping the monetary transaction card to the device at the receiving end 116 to initiate the transaction. Upon entering the amount to be transacted, the device will ask for a security code before allowing the transaction to be completed as a means of authentication. In one embodiment, the security code may be pre-defined and may be stored in a memory of the monetary transaction means, the same may be stored with the device at the POC when data associated to the monetary transaction means was transacted to the device during initiation of the process.

The processor 106 is further configured to authenticate the monetary transaction means for a closed loop network. In one embodiment, the authentication may be performed by comparing the security code entered by the user at the time of the transaction with the security code which is prestored at the receiving end. More specifically, the processor 106 verify the security code entered by the user with a pre-stored code, wherein the pre-stored code is encrypted within the monetary transaction means.

Consequently, the processor 106 completes the monetary transaction upon receiving a positive authentication result and a positive verification code. As a result, the processor 106 store the completed monetary transaction in the memory of the device associated to the receiving end116.

Furthermore, the processor 106 transfers the money from a financial institution associated to the user to a financial institution associated with the receiving end upon connecting the receiving end to the network. more specifically, the processor 106 may sync data associated to the transaction of the pre-defined amount with a backend server upon connecting the processor 106 to internet.

In operation, in one exemplary embodiment, a user may transfer ‘X’ amount of rupees which is in its digital form; and which is linked to a card 104, from a financial account, to the pooled account 110, via the network 112. Further, the user may also choose the currency of interest based on which the processor 106 coverts the ‘X’ amount of rupees into its equivalent virtual amount. Consequently, the user can use the amount ‘X’ to swipe via the card 104 in a closed loop manner at any receiving end 116 from the transaction end 114, even without the internet connectivity. In one embodiment, the user may allocate a fixed amount in the corresponding wallet which is specifically used for transactions offline. In a situation, the user may go to a vendor having a POS machine which is integrated and installed with an application associated to the offline monetary transaction, wherein the application is synced with the device at the receiving end, the monetary transaction means (here the card) and a main server to which the details of the POS and the details of the monetary transaction means are linked. When the user taps the card on an interface of the POS machine using the near field communication technique, the POS identifies the card through one of the at least two chips installed on the card. Further, upon identifying the card, the POS machine askes the user to enter the security code which may be in a form of a code. On receiving the code from the user, the POS verifies and authenticates the card of the user. On successful authentication, the user is allowed to complete the transaction. Subsequently, when the user comes in contact with the internet anytime after the transaction at any receiving end 116, the processor 106 syncs the transaction data which is in link with the amount ‘X’ with the backend server to keep a track of the transactions made by the user in absence and/or presence of the internet.

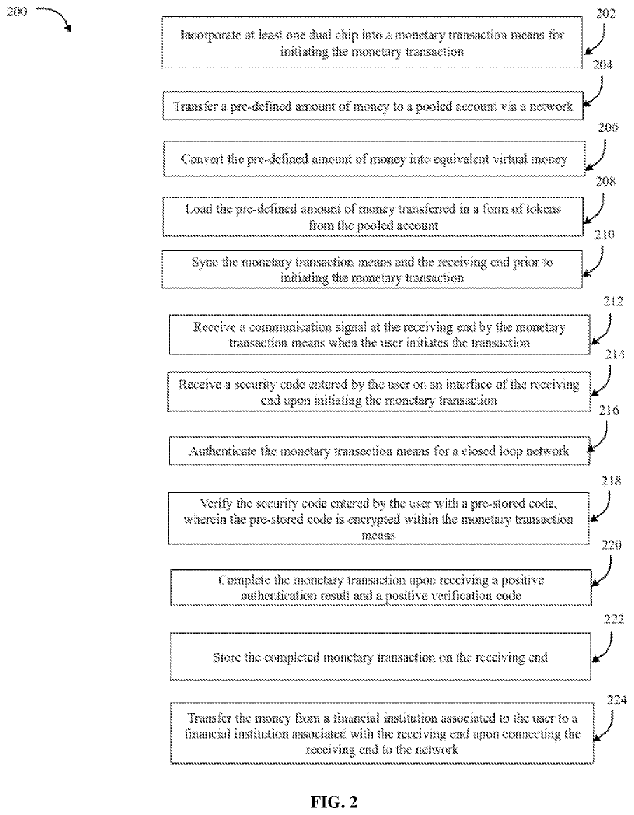

FIG. 2 illustrates an exemplary representation of a flow chart representing steps involved in a method 200 for monetary transaction in accordance with an aspect of the present invention. The money 200 includes incorporating at least two chip into a monetary transaction means for initiating the monetary transaction in step 202. In one embodiment, incorporating the at least two chips into the monetary transaction means may include incorporating the at least two chips into at least one of a debit card, a credit card or a prepaid card.

The method 200 also includes transferring a pre-defined amount of money to a pooled account via a network in step 204. Furthermore, the method 200 includes converting the pre-defined amount of money into equivalent virtual money in step 206. The method 200 also includes loading the pre-defined amount of money transferred in a form of tokens from the pooled accountin step 208.

The method 200 also includes syncing the monetary transaction means and the receiving end prior to initiating the monetary transaction in step 210. In one embodiment, syncing the monetary transaction means and the receiving endmay include syncing the monetary transaction means withat least one of a POS, a mobile embedded application, or a kiosk.

The method 200 also includes receiving a communication signal at the receiving end by the monetary transaction means when the user initiates the transaction 212. The method 200 further includes receiving a security code entered by the user on an interface of the receiving end upon initiating the monetary transaction 214.

Furthermore, the method 200 includes authenticating the monetary transaction means for a closed loop network 216. The method 200 also includes verifying the security code entered by the user with a pre-stored code, wherein the pre-stored code is encrypted within the monetary transaction means 218. The method 200 also includes completing the monetary transaction upon receiving a positive authentication result and a positive verification code in step 220. The method 200 also includes storing the completed monetary transaction on the receiving end in step 222. Furthermore, the method 200 includes transferring the money from a financial institution associated to the user to a financial institution associated with the receiving end upon connecting the receiving end to the network in step 224.

In one exemplary embodiment, the method 200 may further include syncing data associated to the transaction of the pre-defined amount with a backend server upon connecting the processor to internet.

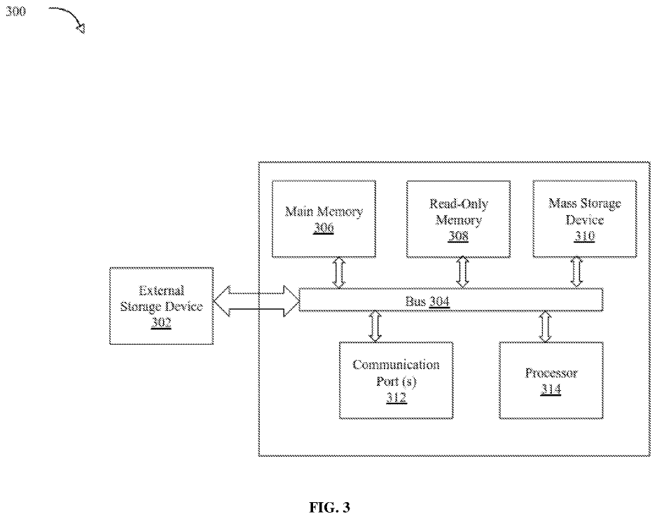

FIG. 3 refers to the exemplary computer system 300 in which or with which embodiments of the present invention can be utilized, in accordance with embodiments of the present disclosure. As shown in FIG. 3, computer system 300 can include an external storage device 302, a bus 304, a main memory 306, a read only memory 308, a mass storage device 310, communication port 312, and a processor 314. A person skilled in the art will appreciate that the computer system may include more than one processor and communication ports. Examples of processor 314 include, but are not limited to, an Intel® Itanium® or Itanium 2 processor(s), or AMD® Opteron® or Athlon MP® processor(s), Motorola® lines of processors, FortiSOC™ system on chip processors or other future processors. Processor 914 may include various modules associated with embodiments of the present invention. Communication port 312 can be any of an RS-232 port for use with a modem-based dialup connection, a 10/100 Ethernet port, a Gigabit or 10 Gigabit port using copper or fiber, a serial port, a parallel port, or other existing or future ports. Communication port 912 may be chosen depending on a network, such a Local Area Network (LAN), Wide Area Network (WAN), or any network to which computer system connects.

Memory 306 can be Random Access Memory (RAM), or any other dynamic storage device commonly known in the art. Read-only memory 308 can be any static storage device(s) e.g., but not limited to, a Programmable Read Only Memory (PROM) chips for storing static information e.g., start-up or BIOS instructions for processor 314. Mass storage 310 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7102 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 304 communicatively couples the processor(s) 314 with the other memory, storage and communication blocks. Bus 904 can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 314 to software system.

Optionally, operator and administrative interfaces, e.g. a display, keyboard, and a cursor control device, may also be coupled to bus 304 to support direct operator interaction with a computer system. Other operator and administrative interfaces can be provided through network connections connected through communication port 312. The external storage device 302 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system limit the scope of the present disclosure.

As used herein, and unless the context dictates otherwise, the term “coupled to” is intended to include both direct coupling (in which two elements that are coupled to each other or in contact with each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While some embodiments of the present disclosure have been illustrated and described, those are completely exemplary in nature. The disclosure is not limited to the embodiments as elaborated herein only and it would be apparent to those skilled in the art that numerous modifications besides those already described are possible without departing from the inventive concepts herein. All such modifications, changes, variations, substitutions, and equivalents are completely within the scope of the present disclosure. The inventive subject matter, therefore, is not to be restricted except in the appended claims.

### ADVANTAGES OF THE INVENTION

The present invention providesa provide system and method to for monetary transaction

The present invention also providesa system and method to for offline monetary transaction.

The present invention also provides a more reliable and more efficient system and method for offline monetary transaction.

The present invention also providesa system and method of dual wallet on single or dual chip cards.

The present invention also provides a system and method to work under Closed loop wallet which is capable to work in parallel with existing traditional online/offline wallet.

We claim:

1. A system (100) for monetary transaction, said system (100) characterized by comprising:
two or more chips (102) incorporated into a monetary transaction means (104), wherein the chips (102) are configured to initiate the monetary transaction;
a receiving end (116) configured to enable a user to perform the monetary transaction using the monetary transaction means (104), wherein the receiving end (116) comprising:
a processor (106);
a memory (108) comprising a set of instructions, which when executed by the processor (106) cause the processor (106) to:
transfer a pre-defined amount of money to a pooled account (110) via a network (112);
load the pre-defined amount of money transferred in a form of tokens from the pooled account (110);
sync the monetary transaction means (104) and the receiving end (116) prior to initiating the monetary transaction;
receive a communication signal at the receiving end (116) by the monetary transaction means (104) when the user initiates the transaction;
receive a security code entered by the user on an interface of the receiving end (116) upon initiating the monetary transaction;
authenticate the monetary transaction means (104) for a closed loop network;
verify the security code entered by the user with a pre-stored code, wherein the pre-stored code is encrypted within the monetary transaction means (104);
complete the monetary transaction upon receiving a positive authentication result and a positive verification code;
store the completed monetary transaction on the receiving end (116); and
transfer the money from a financial institution associated to the user to a financial institution associated with the receiving end (116) upon connecting the receiving end (116) to the network (112).

2. The system (100) as claimed in claim 1, wherein the monetary transaction means (104) comprises at least one of a debit card, a credit card or a prepaid card.

3. The system (100) as claimed in claim 2, wherein at least one of the debit card and the credit card comprises one of a dual chip single interface card or a single chip dual interface card or a prepaid card.

4. The system (100) as claimed in claim 1, wherein the chips (102) correspond to a contactless chip.

5. The system (100) as claimed in claim 1, wherein the receiving end (116) comprises at least one of a POS, a mobile embedded application, or a kiosk.

6. The system (100) as claimed in claim 1, wherein the processor (106) is configured to sync data associated to the transaction of the pre-defined amount with a backend server upon connecting the processor (106) to internet.

7. A method (200) for monetary transaction, said method (200) comprising:
incorporating two or more chips (102) into a monetary transaction means (104) for initiating the monetary transaction of the system (100);
transferring, by a processor (106) at the receiving end (116), a pre-defined amount of money to a pooled account (110) via a network (112);
loading, by the processor (106), the pre-defined amount of money transferred in a form of tokens from the pooled account (110);
syncing, by the processor (106), the monetary transaction means (104) and the receiving end (116) prior to initiating the monetary transaction;
receiving, by the processor (106), a communication signal at the receiving end (116) by the monetary transaction means (104) when the user initiates the transaction;
receiving, by the processor (106), a security code entered by the user on an interface of the receiving end (116) upon initiating the monetary transaction;
authenticating, by the processor (106), the monetary transaction means (104) for a closed loop network;
verifying, by the processor (106), the security code entered by the user with a pre-stored code, wherein the pre-stored code is encrypted within the monetary transaction means (104);
completing, by the processor (106), the monetary transaction upon receiving a positive authentication result and a positive verification code;
storing, by the processor (106), the completed monetary transaction on the receiving end (116); and
transferring, by the processor (106), the money from a financial institution associated to the user to a financial institution associated with the receiving end (116) upon connecting the receiving end (116) to the network (112).

8. The method (200) as claimed in claim 7, wherein incorporating the chips (102) into the monetary transaction means (104) comprises incorporating the chips (102) into at least one of a debit card, a credit card or a prepaid card.

9. The method (200) as claimed in claim 7, wherein storing the completed monetary transaction on the receiving end (116) comprises storing the completed monetary transaction on at least one of a POS, a mobile embedded application, or a kiosk.

10. The method (200) as claimed in claim 7, comprising syncing, by the processor (106), data associated to the transaction of the pre-defined amount with a backend server upon connecting the processor (106) to internet.
